(19) United States
(12) Patent Application Publication
(10) Pub. No.: US 2010/0122039 A1
(43) Pub. Date: May 13, 2010

(54) Memory Systems and Accessing Methods

(76) Inventors: Ravi Ranjan Kumar, Bangalore (IN); Sreekumar Padmanabhan, Bangalore (IN)

Correspondence Address: SLATER & MATSIL LLP, 17950 PRESTON ROAD, SUITE 1000, DALLAS, TX, 75252, US

(21) Appl. No.: 12/268,732

(22) Filed: Nov. 11, 2008

(51) Int. Cl. G06F 12/00; G06F 12/02

(52) U.S. Cl. 711/147; 711/149; 711/170; 711/E12.001; 711/E12.002

(57) ABSTRACT

Memory systems and accessing methods are disclosed. In one embodiment, a method of accessing a memory device includes accessing a first end of the memory device regarding a first data type, and accessing a second end of the memory device regarding a second data type.

### TECHNICAL FIELD

The present invention relates generally to memory devices, and more particularly to memory systems and memory accessing methods.

### BACKGROUND

Computer systems are used in many applications. A computer system has many components that function and communicate together to provide a computing operation. Memory devices are components used in computer systems and other electronic devices and applications. Memory devices are used to store information and/or software programs, as examples.

Memory devices of computer systems include hard drives, random access memory (RAM) devices, read only memory (ROM) devices, and caches, as examples. Computers may also include removable storage devices such as CD's, floppy disks, and memory sticks. Data is generally stored in memory devices as digital information, e.g., as a “0” or “1.”

Memory in computer systems is often limited. As end applications and software become more complex, the demand for memory increases. However, adding additional memory and storage locations can be costly, or there may not be additional space in some computing systems for adding more memory. Often the purchase of a new computer is needed in order to provide increased amounts of memory or storage space.

Thus, what are needed in the art are more efficient methods of utilizing and accessing memory devices in computer systems and other electronic applications.

### SUMMARY OF THE INVENTION

Technical advantages are generally achieved by embodiments of the present invention, which include novel memory systems and methods of accessing memory devices.

In accordance with one embodiment, a method of accessing a memory device includes accessing a first end of the memory device regarding a first data type. A second end of the memory device is accessed regarding a second data type.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a memory device in accordance with an embodiment of the present invention;

FIG. 2 illustrates a method of accessing a memory device in accordance with an embodiment of the present invention;

FIG. 3 illustrates a register of a portion of a memory device in accordance with an embodiment of the present invention;

FIG. 4 is a block diagram illustrating a computing system implementing a memory device in accordance with an embodiment of the present invention;

FIG. 5 is a flow chart showing a method of accessing a memory device or system for a data type in accordance with an embodiment of the present invention; and

FIG. 6 illustrates a memory device dividable into multiple sections for storing groups of two data types in accordance with another embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In computer systems, different applications may have various memory size requirements for each type of data. In systems that support multiple applications, the memory depth required for each data type is required to be set to a maximum level in order to cater to the application having the highest memory requirement. This results in inefficient utilization of memory when any one of data type does not require the maximum depth memory for a particular application, resulting in poor memory space utilization and a limited scope for future expansion.

Embodiments of the present invention comprise integrated memory devices and systems that have a dynamic memory depth adjustment. A memory device is subdivided into at least two regions for different data types. A shared region between the two regions provides the ability to dynamically change the depth of the available memory space in the memory device for each data type, depending on the memory space requirements for each data type during the operation of the memory device. The data for each data type is accessed from opposite ends of the memory devices, or from opposite ends of sections of the memory devices.

The present invention will be described with respect to preferred embodiments in a specific context, namely implemented in memory devices for computer systems. The invention may also be applied, however, to other applications where memory devices are used. Embodiments of the present invention may be implemented in computer and other systems where memory devices are used to store more than one type of data and at any time, it is required to access one of the data types from the memory devices, for example.

Embodiments of the present invention provide novel methods of storing data in memory devices. Memory storage requirements are more efficiently handled by storing two or more data types in a combined memory. Dynamically configurable watermarks are used to subdivide a single memory device for each data type stored, providing memory depth variation in the memory device for each data type. These configurations are user programmable and may be included in a chip register map for the memory device, for example.

The memory requirements for a plurality of different data types are integrated into a single larger memory, e.g., that is larger than separate memories used for single data types. The larger memory is then dynamically and flexibly subdivided into different regions for each data type, based on the application. Individually register configurable watermark levels are used to efficiently subdivide the memory device. The watermarks function as thresholds and control the memory depth for each data type. Because the watermarks are dynamically configurable, the memory depth of each data type may be varied automatically, depending on the application, for example.

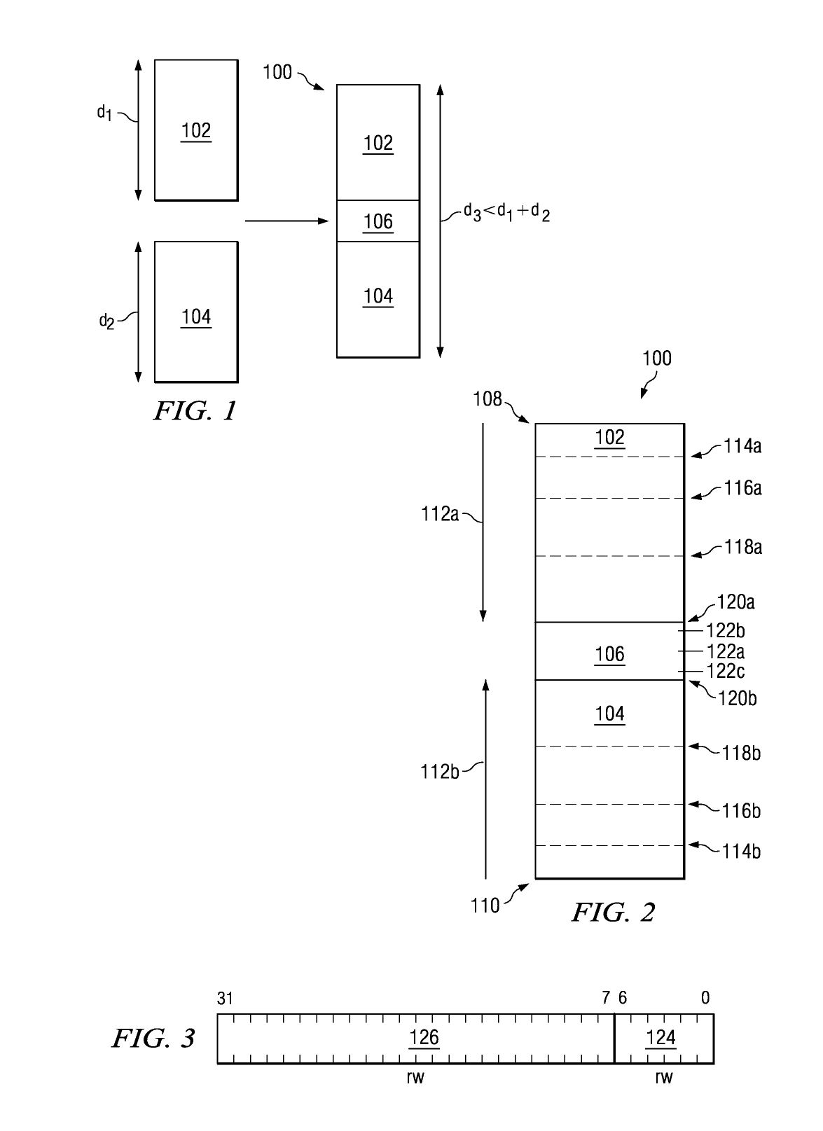

With reference now to FIG. 1, there is shown a memory device 100 in accordance with an embodiment of the present invention. The memory device 100 comprises a first region 102, a second region 104, and a shared region 106 disposed between the first region 102 and the second region 104. Data of a first data type DT1 is storable and retrievable in the first region 102. Data of a second data type DT2 is storable and retrievable in the second region 104.

The first data type DT1 and the second data type DT2 may comprise different types of data or different parts of data. For example, first data type DT1 may comprise header information, and second data type DT2 may comprise body information. The first data type DT1 may comprise body information, and the second data type DT2 may comprise header information. Alternatively, the first and second data types DT1 and DT2 may comprise other types or parts of data.

Data of the first data type DT1 is also storable and retrievable in a portion of the shared region 106 proximate the first region 102. Data of the second data type DT2 is storable and retrievable in a portion of the shared region 106 proximate the second region 104. The depth within the shared region 106 that the first data type DT1 and the second data type DT2 may be stored is variable, depending on the amount of memory needed for each data type DT1 or DT2. Thus, the shared region 106 allows for a dynamic allocation of memory for each data type DT1 and DT2, in accordance with embodiments of the present invention. The shared region 106 provides an adjustable memory depth for data of the first data type DT1 storable proximate the first end of the memory device 100 and for data of the second data type DT2 storable proximate the second end of the memory device 100. The shared region 106 provides a means for dynamically changing the boundary between the first region 102 and the second region 104 of memory cells in the memory device 100, for example.

Considered separately, as shown on the left side of FIG. 1, the memory requirements for the first data type DT1 in the first region 102 may comprise a depth d₁, and the memory requirements for the second data type DT2 in the second region 104 may comprise a depth d₂. However, when the first region 102 and second region 104 are implemented in a single memory device 100 comprising a unified memory in accordance with embodiments of the present invention, the first region 102, second region 104, and shared region 106 together comprise a memory depth d₃ that is less than (d₁+d₂) .

FIG. 2 illustrates a memory device 100 in accordance with an embodiment of the present invention. The memory device 100 comprises an array of memory cells (not shown) that may be arranged in rows and columns. The memory device 100 may comprise a dynamic random access memory (DRAM), static random access memory (SRAM), read only memory (ROM), or other types of memory chips, for example. The memory device 100 comprises a first end 108 and a second end 110, the second end 110 being opposite the first end 108 in the memory array. The first end 108 may comprise an address of 0, and the second end 110 may comprise an address of (d₃−1), as examples. Alternatively, the memory device 100 may comprise other sizes.

The first end 108 may comprise a first cell in a first row of the memory array, for example. The second end 110 may comprise a last cell in a last row of the memory array, for example. The second end 110 may alternatively comprise a first cell in the last row of the memory array, as shown in FIG. 2, for example.

The memory device 100 may be accessed using a pointer 112a for the first region 102 and a pointer 112b for the second region 104. The pointers 112a and 112b may be controlled using software or hardware and are used to read out or write to the memory device 100. A plurality of watermarks 114a, 116a, 118a, and 120a is defined within the first region 102, and a plurality of watermarks 114b, 116b, 118b, and 120b is defined within the second region 104, as shown. The watermarks 114a, 116a, 118a, and 120a define thresholds of memory depth within the first region 102. Likewise, watermarks 114b, 116b, 118b, and 120b define thresholds of memory depth within the second region 104. The watermarks 114a, 116a, 118a, 120a, 114b, 116b, 118b, and 120b define the depth of each data type DT1 or DT2 in the first region 102 and the second region 104.

Watermarks 114a and 114b may comprise an “almost empty” level, status, or threshold within the first and second regions 102 and 104, respectively. Watermarks 116a and 116b may comprise a “refill from empty” level, status, or threshold within the first and second regions 102 and 104, respectively. Watermarks 118a and 118b may comprise a “refill from full” level, status, or threshold within the first and second regions 102 and 104, respectively. Watermarks 120a and 120b may comprise an “almost full” level, status, or threshold within the first and second regions 102 and 104, respectively. Alternatively, other types and numbers of watermarks may be implemented in the first region and second region 102 and 104, for example.

The pointer 112a and the watermarks 114a, 116a, 118a, and 120a are used to access the first region 102 of the memory device 100 to store and retrieve data of the first data type DT1. The pointer 112b and the watermarks 114b, 116b, 118b, and 120b are used to access the second region 104 of the memory device 100 to store and retrieve data of the second data type DT2.

The watermarks 114a, 116a, 118a, 120a, 114b, 116b, 118b, and 120b may be established dynamically during the operation of the memory device 100, for example. The watermarks 114a, 116a, 118a, 120a, 114b, 116b, 118b, and 120b may be configured using a register, for example. The watermarks 114a, 116a, 118a, 120a, 114b, 116b, 118b, and 120b may be implemented in a chip register map (CRM) of the memory device 100, as an example.

The shared region 106 provides for the dynamic allocation of the memory space of the memory device 100. The shared region 106 may be used to store either the first data type DT1 or the second data type DT2, or both, depending on the requirements for storage of the application the memory device 100 is implemented in. The amount of data type DT1 or DT2 storable in the shared region 106 may vary at a plurality of movable points within the shared region 106, as shown at 122a, 122b, and 122c. The shared region 106 can vary from 0 to the depth of the memory 100 based on dynamically configurable thresholds. If about the same amount of the first data type DT1 is required to be stored as the amount of the second data type DT2, point 122a located in a substantially central region of the memory device 100 may be used to define the boundary in the memory device 100 between the first data type DT1 and second data type DT2 storage. If more second data type DT2 storage space is needed, point 122b may be used as the boundary, or if more first data type DT1 storage space is needed, point 122c may be used as the boundary, as examples.

FIG. 3 shows a register for a watermark of the first region 102 or the second region 104, as an example. The register is read/write (rw) and includes a region 124 for the watermark or threshold, and a reserved region 126 (RES). The bits of the reserved region 126 may comprise 31:7, and the bits of the watermark region 124 may comprise 6:0, as shown, as an example. A register may be established or configured for each watermark, for example. The registers may also be configured in a variety of configurations depending on the memory device 100 and the application, not shown.

Examples of register descriptions for the watermarks 114a, 116a, 118a, 120a, 114b, 116b, 118b, and 120b will next be described. A register description of the watermark 114a for the almost empty threshold in the first region 102 is shown in Table 1. The reset value may be 0000 0008_{H}, and the almost empty threshold may be specified as a multiple of n which defines the granularity of the thresholds, for example.

TABLE 1

| Field | Bits | Type | Description |
|---|---|---|---|
| RES | 31:7 | rw | Reserved |
| AE1 | 6:0 | rw | DT1 almost empty threshold as a |
| | | | multiple of n |

The register description of the watermark 116a for the refill from empty threshold in the first region 102 is shown in Table 2. The reset value may be 0000 0010_{H}, and the refill from empty threshold may be specified as a multiple of n which defines the granularity of the thresholds, for example.

TABLE 2

| Field | Bits | Type | Description |
|---|---|---|---|
| RES | 31:7 | rw | Reserved |
| RE1 | 6:0 | rw | DT1 refill from empty threshold as a |
| | | | multiple of n |

The register description of the watermark 120a for the almost full threshold in the first region 102 is shown in Table 3. The reset value may be 0000 0058_{H}, and the almost full threshold may be specified as a multiple of n which defines the granularity of the thresholds, for example.

TABLE 3

| Field | Bits | Type | Description |
|---|---|---|---|
| RES | 31:7 | rw | Reserved |
| AF1 | 6:0 | rw | DT1 almost full threshold as a multiple |
| | | | of n |

The register description of the watermark 118a for the refill from full threshold in the first region 102 is shown in Table 4. The reset value may be 0000 0050_{H}, and the refill from full threshold may be specified as a multiple of n which defines the granularity of the thresholds, for example.

TABLE 4

| Field | Bits | Type | Description |
|---|---|---|---|
| RES | 31:7 | rw | Reserved |
| RF1 | 6:0 | rw | DT1 refill from full threshold as a |
| | | | multiple of n |

The register description of the watermark 114b for the almost empty threshold in the second region 104 is shown in Table 5. The reset value may be 0000 0004_{H}, and the almost empty threshold may be specified as a multiple of n which defines the granularity of the thresholds, for example.

TABLE 5

| Field | Bits | Type | Description |
|---|---|---|---|
| RES | 31:7 | rw | Reserved |
| AE2 | 6:0 | rw | DT2 almost empty threshold as a |
| | | | multiple of n |

The register description of the watermark 116b for the refill from empty threshold in the second region 104 is shown in Table 6. The reset value may be 0000 0008_{H}, and the refill from empty threshold may be specified as a multiple of n which defines the granularity of the thresholds, for example.

TABLE 6

| Field | Bits | Type | Description |
|---|---|---|---|
| RES | 31:7 | rw | Reserved |
| RE2 | 6:0 | Rw | DT2 refill from empty threshold as a |
| | | | multiple of n |

The register description of the watermark 120b for the almost full threshold in the second region 104 is shown in Table 7. The reset value may be 0000 001C_{H}, and the almost full threshold may be specified as a multiple of n which defines the granularity of the thresholds, for example.

TABLE 7

| Field | Bits | Type | Description |
|---|---|---|---|
| RES | 31:7 | rw | Reserved |
| AF2 | 6:0 | rw | DT2 almost full threshold as a multiple |
| | | | of n |

The register description of the watermark 118a for the refill from full threshold in the first region 102 is shown in Table 8. The reset value may be 0000 0018_{H}, and the refill from full threshold may be specified as a multiple of n which defines the granularity of the thresholds, for example.

TABLE 8

| Field | Bits | Type | Description |
|---|---|---|---|
| RES | 31:7 | rw | Reserved |
| RF2 | 6:0 | rw | DT2 refill from full threshold as a |
| | | | multiple of n |

These watermarks are register configurable and can be changed dynamically, during the operation of the system the memory device 100 is implemented in. In some embodiments, the dynamic configuration changes satisfy the following inequalities shown in Equations 1 through 4, so that they are considered valid:

Almost empty_{—}DT1<(Refill_from_empty_{—}DT1 & Almost_empty_{—}DT2)<Refill_from empty_{—}DT2; Eq. 1

Almost_full_{—}DT1>(Refill_from_full_{—}DT1 & Almost_full_{—}DT2)>Refill_from_full_{—}DT2; Eq. 2

Almost_full_{—}DT1>(Almost empty_{—}DT1 & Almost_full_{—}DT2)>Almost_empty_{—}DT2; Eq. 3

and

Almost_full_{—}DT1+Almost_full_{—}DT2<d₃ (the total memory device 100 depth). Eq. 4

Referring again to FIG. 2, the memory device 100 organization with respect to the thresholds watermarks in the first region 102 and second region 104 is shown. Because there is no critical division for the first data type DT1 memory full or the second data type DT2 memory full, the shared region 106 between the first region 102 and the second region 104 comprises a region where either a first data type DT1, a second data type DT2, or both, may be stored. The first region 102 and second region 104 are organized as last in first out (LIFO), and the head of the LIFO portions of the memory device 100 comprises the pointers 112a and 112b, respectively. The occupancy calculation for the data types DT1 and DT2 stored in the first region 102 and second region 104 are different. For example, the occupancy calculation for the first region 102 of the memory device 100 is shown in Eq. 5, and the occupancy calculation for the second region 104 for a memory device 100 having a storage capacity of d₃, (a memory depth of 4096, as one example) is shown in Eq. 6:

Occupancy₁₀₂=pointer 112a; and Eq. 5

Occupancy₁₀₄=d₃−pointer 112b. Eq. 6

The number of data types DT1 and DT2 to be stored on-chip memory is dependent on the application where the chip or memory device 100 is being used. In some cases, a greater number of first data types DT1 compared to the number of second data types DT2 may be required to be stored. In other cases a substantially equal number of the first data types DT1 and the second data types DT2 may be required. Advantageously, rather than requiring two separate memory chips for each data type DT1 and DT2, embodiments of the present invention provide a single combined memory device 100 with configurable sub-divisions for two data types DT1 and DT2. Hence, efficient memory device 100 utilization is achieved.

The unified memory device 100 is organized in two LIFO regions, the first region 102 and the second region 104. The register configurable watermarks 114a, 116a, 118a, 120a, 114b, 116b, 118b, and 120b are defined for the first data type DT1 and the second data type DT2 for efficient LIFO management. For example, when the occupancy of the first data type DT1 (or the second data type DT2) equals the almost empty DT1 watermark 114a (or almost empty DT2 watermark 114b), an engine is triggered to start fill-in of the first data type DT1 (or second data type DT2) pointers. This fill-in process is adapted to stop when the occupancy reaches the value of the refill from empty DT1 watermark 116a (or refill from empty DT2 watermark 116b). Similarly, when the first data type DT1 (or the second data type DT2) occupancy reaches the level of the almost full DT1 watermark 120a (or almost full DT2 watermark 120b), an engine is triggered to start read-out of the first data type DT1 (or the second data type DT2) pointers. The reading-out process is adapted to stop when the first data type DT1 (or second data type DT2) occupancy reaches the level of the refill from full DT1 watermark 118a (or refill from full DT2 watermark 118b). Thus, the watermarks 114a, 116a, 118a, 120a, 114b, 116b, 118b, and 120b may be used to control the effective depth of the first data type DT1 and the second data type DT2 in the memory device 100.

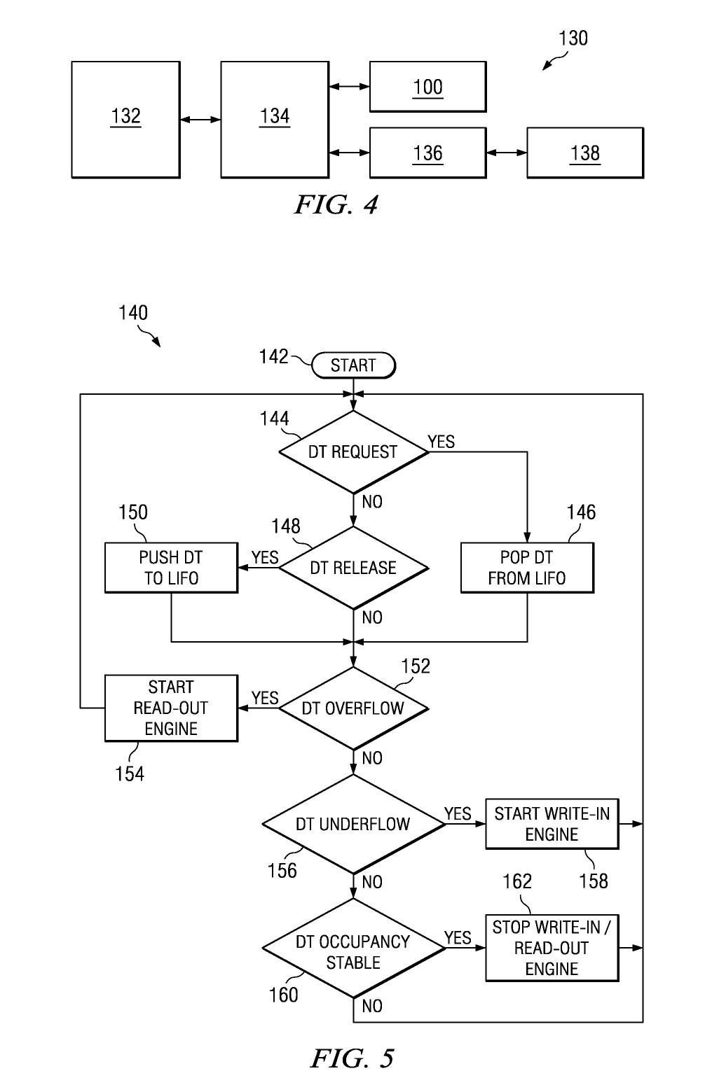

FIG. 4 is a block diagram illustrating a computer system 130 implementing a memory system or memory device 100 in accordance with an embodiment of the present invention. The computer system 130 includes a processor 132 that may comprise a central processing unit (CPU) or other type of information processing device coupled to a controller 134. The controller 134 may be coupled to the memory system or device 100 and to input/output ports or devices 136. The input/output (IO) ports or devices 136 may be coupled to peripheral devices 138 such as a printer, keyboard, mouse, and other devices, for example.

FIG. 5 is a flow chart 140 of accessing a memory device or system 100 for a data type DT in accordance with an embodiment of the present invention. The flow chart 140 illustrates the overall operation of the memory system 100 for one cycle for a request (read) or a release (write) of a data type. The operation of the memory device 100 is similar for both a first data type DT1 and a second data type DT2. The flow chart 140 is shown with a data type DT that may comprise a first data type DT1 or a second data type DT2, for example.

First, the operation is started (step 142). If a data type DT request is made to the memory device 100 (step 144), e.g., by a controller 134 shown in FIG. 4, requesting a data type either DT1 or DT2, the data or information of the data type (DT) is popped from LIFO (step 146), meaning that the data that entered the memory device 100 last is read. If the data type DT is released (step 148), then the data type is then pushed to LIFO (step 150). The pointer 112a or 112b is analyzed to determine if the data type DT is in an overflow status (step 152). If so, a read-out engine is started (step 154), and the cycle is over or completed. If not, the pointer 112a or 112b is analyzed to determine if the data type is in an underflow status (step 156). If so, a write-in engine is started (step 158), and the cycle is over. If not, the occupancy for the data type DT is examined to determine if it is stable. If so, a write-in/read-out engine is stopped (step 162), and then the cycle is over. The next cycle is then started again with step 142.

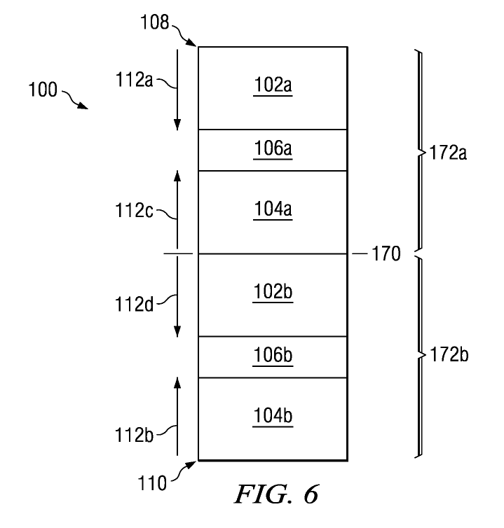

FIG. 6 illustrates another embodiment of the present invention, wherein the memory device 100 is adapted to store three or more types of data types. In the previous embodiments, only two types of data, a first data type DT1 and a second data type DT2 were described as being storable in the memory device 100. However, in other embodiments, the invention may be extended to store any even number of data types, e.g., m=2n, where n comprises a number of sections 172a and 172b that the memory device 100 is divided into, and m comprises the number of data types storable in the memory device 100. In this embodiment, (n−1) static configurations may be used to partition the LIFO pairs of data types DT1 and DT2. Dynamic depth variation can be achieved between each pair of data types DT1 and DT2 storable within the sections 172a and 172b of the memory device 100.

In FIG. 6, a memory device 100 is dividable into sections 172a and 172b for storing groups of two data types. Only two sections are shown in FIG. 6; alternatively, the memory device 100 may be divided into three or more sections, with each section being adapted to store two data types. If there are four data types, the memory device 100 is divided or partitioned at 170, e.g., which may be a central region of the device 100 or other location. Each section 172a or 172b is adapted to store two of the data types DT1, DT2 . . . DTx, wherein x is an even number.

Data is stored beginning at a first end of section 172a for a first data type DT1 in a first region 102a of section 172a, and data is stored beginning at a second end of section 172a for a second data type DT2 in a second region 104a of section 172a. Pointers 112a and 112c are used to access the data in section 172a. The shared region 106a may be used for either data type DT1 or DT2. Data is stored beginning at a first end of section 172b for a third data type DT3 in a first region 102b of section 172b, and data is stored beginning at a second end of section 172b for a fourth data type DT4 in a second region 104b of section 172b. Pointers 112d and 112b are used to access the data in section 172b. The shared region 106b may be used for either data type DT3 or DT4. The watermarks 114a, 116a, 118a, 120a, 114b, 116b, 118b, and 120b and previously described herein may be used for efficient LIFO management within each section 172a and 172b.

Embodiments of the present invention also include methods of accessing memory devices and memory systems 100. For example, in one embodiment, a method of accessing a memory device 100 includes accessing a first end 108 of the memory device 100 proximate the first region 104 regarding a first data type DT1, and accessing a second end 110 of the memory device 100 proximate the second region 104 regarding a second data type DT2. Accessing the first end 108 and the second end 110 may comprise storing data or reading data, for example. The shared region 106 provides the ability to dynamically adjust the memory depth of the memory device 100 for the first region 102 or the second region 104 where the data of the first data type DT1 and the second data type DT2, respectively is stored.

Advantages of embodiments of the invention include providing novel memory devices 100 that comprise integrated memories having the capability of dynamic memory depth adjustment. The memory devices 100 and methods of accessing thereof provide efficient memory utilization and reduces the memory area required, e.g., in comparison to requiring multiple physical memory devices. The dynamic configurations of the memory devices 100 allow flexible partitioning adapted to support many applications. The memory devices 100 and methods of accessing memory devices 100 provide flexible allocation of space for two or more data types.

Space in the memory device 100 the first data type DT1 and the second data type DT2 is allocated based on a plurality of thresholds or watermarks 114a, 116a, 118a, 120a, 114b, 116b, 118b, and 120b that are dynamically programmable, thus modifying the space in the memory device 100 for the first data type DT1 and the second data type DT2 dynamically. The thresholds 114a, 116a, 118a, 120a, 114b, 116b, 118b, and 120b are defined so that the shared region 106 disposed between the first end 108 and the second end 110 of the memory device 100 may vary from about 0 to about the total depth d₃ of the memory device 100.

Embodiments of the present invention are useful in storing types of data where the sequence of arrival of data is immaterial, for example. Thus, embodiments of the present invention may be used where there is no distinction between first arrived data or last arrived data for a particular data type, for example. Also, at any point in time, only one of the data types is required.

Embodiments of the present invention may be implemented on a chip or integrated circuit that has multiple functions on one chip. For example, embodiments of the present invention may be implemented in network processor integrated circuits that include one or more processors and one or more memory devices. The memory devices 100 provide the ability to reduce the area required by memory on the chip, which reduces cost and complexity of the integrated circuit. Embodiments of the present invention may be used to reduce the number of memory devices 100 used in a system and also to reduce the total area occupied by memory devices 100, for example.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of accessing a memory device, the method comprising:
accessing a first end of the memory device regarding a first data type; and
accessing a second end of the memory device regarding a second data type.

2. The method according to claim 1, wherein accessing the first end of the memory device regarding the first data type comprises storing data of at least one first data type, and wherein accessing the second end of the memory device regarding the second data type comprises storing data of at least one second data type.

3. The method according to claim 1, wherein accessing the first end of the memory device regarding the first data type comprises reading data of at least one first data type, and wherein accessing the second end of the memory device regarding the second data type comprises reading data of at least one second data type.

4. The method according to claim 1, further comprising allocating space in the memory device for the first data type and the second data type based on a plurality of thresholds that are dynamically programmable, thus modifying the space in the memory device for the first data type and the second data type dynamically.

5. The method according to claim 4, wherein the thresholds are defined so that a shared region disposed between the first end and the second end of the memory device may vary from about 0 to about the total depth of the memory device.

6. The method according to claim 1, further comprising accessing a shared region of the memory device, the shared region being disposed between the first end and the second end of the memory device.

7. The method according to claim 6, wherein accessing the shared region comprises storing or accessing data of the first data type and/or the second data type.

8. The method according to claim 6, wherein accessing the shared region comprises accessing a shared region that is dynamically configurable between the first end and the second end of the memory device.

9. A method of accessing a memory device, the method comprising:
providing a memory device, the memory device having a first end and a second end opposite the first end and including a plurality of memory cells;
defining a first region of memory cells proximate the first end of the memory device; and
defining a second region of memory cells proximate the second end of the memory device, wherein data of a first data type is storable in memory cells in the first region of the memory device, and wherein data of a second data type is storable in memory cells in the second region of the memory device.

10. The method according to claim 9, further comprising defining a shared region of memory cells between the first region and the second region, wherein data of the first data type or the second data type is storable in the shared region.

11. The method according to claim 10, wherein the shared region provides an adjustable memory depth for data of the first data type storable proximate the first end of the memory device and for data of the second data type storable proximate the second end of the memory device.

12. The method according to claim 9, further comprising establishing at least one threshold proximate the first end or the second end of the memory device.

13. The method according to claim 12, wherein establishing the at least one threshold comprises establishing a threshold for an almost empty status, an almost full status, a refill-from-empty status, and/or a refill-from-full status of a portion of the memory device proximate the first end or the second end of the memory device.

14. The method according to claim 12, wherein establishing the at least one threshold comprises establishing at least one watermark in the memory device.

15. The method according to claim 14, wherein establishing the at least one watermark comprises configuring the at least one watermark using a register.

16. The method according to claim 14, wherein establishing the at least one watermark comprises dynamically establishing the at least one watermark.

17. A memory system, comprising:
a memory device;
means for accessing a first end of the memory device regarding a first data type; and
means for accessing a second end of the memory device regarding a second data type.

18. The memory system according to claim 17, further comprising means for accessing a shared region of the memory device regarding the first data type or the second data type, the shared region being disposed between the first end and the second end of the memory device.

19. The memory system according to claim 18, wherein the memory device is adapted to store m data types, wherein the memory device is dividable into n sections, each section being adapted to store two of the data types, wherein m=2n.

20. The memory system according to claim 19, further comprising means for accessing a first end of each section and a second end of each section for a data type, the second end being opposite the first end of each section.

21. The memory system according to claim 17, wherein the memory device comprises a dynamic random access memory (DRAM), a static random access memory (SRAM), or a read only memory (ROM).

22. A computer system including the memory system according to claim 17, wherein the computer system includes a processor, a controller, one or more input/output ports, and/or peripheral devices coupleable to the memory system.
